(19) United States
(12) Patent Application Publication
(10) Pub. No.: US 2026/0141484 A1
(43) Pub. Date: May 21, 2026

(54) Method for Processing Tiled Images and Optical Device

(71) Applicant: Carl Zeiss Microscopy GmbH, Jena (DE)

(72) Inventors: Markus Eichinger, Tuerkenfeld (DE); Thomas Milde, Nausnitz (DE)

(21) Appl. No.: 19/374,430

(22) Filed: Oct. 30, 2025

(30) Foreign Application Priority Data
Oct. 31, 2024 (DE) 10 2024 131 808.2

(51) Int. Cl. G06T 5/50; G02B 21/36; G06T 3/4038; G06T 5/92

(52) U.S. Cl. CPC G06T 5/50; G02B 21/365; G06T 3/4038; G06T 5/92; G06T 2207/10032; G06T 2207/10052; G06T 2207/10061; G06T 2207/10064; G06T 2207/20212

(57) ABSTRACT

The invention relates to a method for processing tiled images in which a plurality of overlapping tile images Cᵢ(x, y) of a sample are recorded by an optical device. The method is characterized in that an approach for Cᵢ(x, y) and a model function in particular for a shading function Sᵢ(x, y) are predefined, correction factors are determined at support points in an overlap region of adjacent tile images, and the shading function Sᵢ(x, y) and unshaded sample images Bᵢ(x, y) are determined at least approximately in each case. The invention additionally relates to an optical device.

The current application claims the benefit of German Patent Application No. 10 2024 131 808.2, filed on 31 Oct. 2024, which is hereby incorporated by reference.

In a first aspect, the invention relates to a method for processing tiled images according to the preamble of Claim 1. In a further aspect, the invention relates to an optical device according to the preamble of Claim 22.

In a generic method for processing tiled images, a plurality of overlapping tile images Cᵢ(x, y) of a sample are recorded by an optical device.

A generic optical device comprises at least the following components: a detector for detecting emission radiation emitted by a sample in a sample region, a detection beam path having an imaging optical unit for directing the emission radiation onto the detector, a mechanical drive for setting a relative lateral position between the sample and the imaging optical unit with respect to an optical axis of the imaging optical unit, and a control unit configured at least for controlling the mechanical drive and for evaluating measurement data from the detector. The control unit is additionally configured to control the optical device for recording a plurality of overlapping tile images Cᵢ(x, y) of a sample.

In modern microscopy, generally large regions of a sample are imaged with high resolution by images being recorded at different positions using a digital camera or some other type of detector, e.g. a line scanner system. The positions of the individual images are often chosen such that they form a regular grid and the field of view (FOV) of adjacent individual images overlaps by a certain amount, e.g. by 10% of the FOV width or height. The recorded images are generally referred to as tiles, and the entire set of tiles is referred to as a tiled image or mosaic image. In this description, the terms tile and tile image are used synonymously. Such tiled images afford a large field of view and a high resolution, but are beset by two types of artefacts that often make a further analysis more difficult.

The first type of artefacts is caused by inaccuracies in the mechanical devices for positioning the sample relative to the microscope objective and leads to a mismatch of the imaged sample structures which are visible at the tile boundaries. This is generally corrected by so-called stitching algorithms: The imaged sample structures in the overlap region are examined in order to detect positional deviations between adjacent tiles and to calculate appropriate displacements in the horizontal direction (x-direction) and vertical direction (y-direction) for the slightly displaced tiles, so that the imaged structures of the sample at the tile boundaries match as well as possible. Hereinafter, the process of “stitching” is also referred to as structural matching of adjacent tiles.

The second type of artefacts is caused by differences in brightness between the adjacent tiles and tile edges. Such differences in brightness, which may also be referred to as luminance differences, may have various causes: Vignetting, which may be caused by the construction of the imaging light path, hence the illumination beam path and/or the detection beam path, by inhomogeneous illumination or by a location- and/or time-dependent sensitivity of the detector. The sample itself may also be the source of such artefacts: In the case of fluorescence recordings, bleaching may occur in the overlapping regions; in the case of transmitted light or fluorescence recordings, different transmission/emission characteristics of the sample holder or embedding medium may have an influence; a tile image with highly reflective structures often appears brighter at the tile edge than the edge of the adjacent tile if the sample does not have reflective structures in that region. Most of these artefacts exhibit a slow spatial change. Other artefacts with spatially abrupt changes within a tile may be caused, for example, by dust in the light path, defects of the detector or image sensor, or dust directly at or on the detector or image sensor. All of these undesirable effects on the image luminance in their entirety are often referred to as shading artefacts.

Image correction algorithms for rectifying or correcting these shading artefacts are often referred to as de-shading algorithms or background shading correction algorithms [Wu] and can be roughly subdivided into prospective and retrospective methods.

Prospective methods capture shading reference images of calibration samples that have artefacts identical or similar to those of the samples captured later, but do not contain other structures [Young, De Silva]. With the aid of such shading reference images, the luminance artefacts can be compensated for by a simple multiplicative or additive correction scheme. Such algorithms can cope with spatially slow and spatially abrupt changes in luminance, and they can also be applied to non-overlapping tile images. However, they have some disadvantages: It may be difficult or sometimes even impossible to reproduce the shading effects manifested in the real samples by means of a calibration pattern. Furthermore, such methods do not work well if the shading artefacts depend on the tile content itself. To overcome the limitations of using calibration samples, a new method has recently been described which derives a shading correction image from the sample image itself, but requires a specific capture scheme with large tile overlap [Loetgering].

Retrospective methods [Legesse, Smith, Peng] attempt to compensate for shading artefacts by using the captured tile image data themselves. Some methods apply luminance correction only to the overlap region [Legesse]. Such an approach leads to unsatisfactory results for mosaic images with small overlaps and if the shading effect extends beyond the overlap region.

Some methods of this kind attempt to separate the shading artefacts from the sample structures by averaging the image data of all tiles, using low-pass filters or requiring user inputs for separating background regions and sample regions [Smith, Peng]. Other methods improve or combine this scheme by automatically recognizing object regions and background regions and averaging only the background regions [Legesse]. All these approaches that use averaging show good results only if the following prerequisites are met: The tile image must contain a sufficient number of tiles. Moreover, sufficient homogeneity of the sample is required and it must be possible to separate background and sample regions. If only a small number of tiles are available for averaging, or if the sample contains pronounced edges or regions with significantly different luminance, the sample structure will falsify the shading estimation.

Some methods [Wu] model the shadow background by matching 2D surface functions by way of least square fitting of the background pixel intensities or the averaged intensities of the background regions. This approach, too, requires the tile image to contain a sufficient number of background regions suitable for the least square fitting.

The retrospective methods described are based on the unsatisfactory situation that the quality of the calculated shading correction data greatly depends on the sample properties.

An object of the present invention can be considered that of specifying a method for processing tiled images and an optical device in which shading artefacts can be reduced with comparatively little computational complexity and high-quality mosaic images can be attained.

This object is achieved by the method having the features of Claim 1 and by the optical device having the features of Claim 22.

The method of the type specified above is developed according to the invention in that the following method steps are carried out for ascertaining unshaded sample images Bᵢ(x, y):
a) predefining an approach Cᵢ(x, y)=Sᵢ(x, y)Bᵢ(x, y)+Tᵢ(x, y) for the measured tile images Cᵢ(x, y), in which Bᵢ(x, y) is an unshaded sample image to be ascertained of a tile i, Sᵢ(x, y) is a shading function for the tile i,Tᵢ(x, y) is an additive shading term for the tile i and i is a running index of the individual tiles,
b) predefining a model function for the shading function Sᵢ(x, y) and a model term for the additive shading term Tᵢ(x, y),
c) determining correction factors at a plurality of support points in an overlap region of adjacent tile images using the tile images Cᵢ(x, y),
d) at least approximately determining the shading function Sᵢ(x, y) and the shading term Tᵢ(x, y) by fitting the model function predefined in step b) to the correction factors determined in step c)
e) approximately determining an unshaded sample image Bᵢ(x, y) using the shading function Sᵢ(x, y) at least approximately determined in step d) and the at least approximately determined shading term Tᵢ(x, y).

The optical device of the type specified above is developed according to the invention in that the control unit is configured to carry out method steps a) to e) specified above for the method according to the invention for ascertaining unshaded sample images Bᵢ(x, y).

Advantageous exemplary embodiments of the method according to the invention for processing tiled images and of the optical device according to the invention are described below, particularly in association with the dependent claims and the figures.

The optical device can be any type of optical device that can be used to record images of a sample. By way of example, the optical device can be embodied as an aerial image camera. This aerial image camera can be arranged for example in a satellite for recording images of Earth or space.

In particularly preferred exemplary embodiments, the optical device is embodied as a microscope and comprises a radiation source for providing illumination radiation and an illumination beam path for directing the illumination radiation into the sample region, wherein the imaging optical unit comprises a microscope optical unit. The microscope can in principle be any kind of microscope in which an illumination radiation impinges on a sample. For example, the microscope can be an electron microscope or an ion microscope. In particularly preferred exemplary embodiments, the microscope is a light microscope and the microscope optical unit comprises at least one microscope objective. For example, the microscope can realize the function of at least one of the following microscopes: digital microscope, fluorescence microscope, light microscope, transmitted light microscope, reflected light microscope, wide-field microscope, scanning microscope, confocal microscope, light field microscope, light sheet microscope, TIRF microscope, SIM microscope, electron microscope, ion microscope.

Accordingly, in preferred variants of the method according to the invention for processing tiled images, a microscope is used as optical device.

The radiation source can be any radiation source capable of supplying the desired radiation type with the desired wavelength or desired wavelengths and with a suitable intensity. For example, the radiation source can be an electron or ion source.

In preferred exemplary embodiments, the radiation source is a light source. The light source can in principle be any light source capable of supplying the illumination light with a desired wavelength or desired wavelengths and with a suitable intensity. The light source can be a laser or an LED module, for example. The excitation light can be coherent light, at least partially coherent light or non-coherent light. The illumination light is electromagnetic radiation, in particular in the visible spectral range and in adjoining ranges. The illumination light can also be referred to as excitation light; these two terms are used synonymously for the most part in this description.

Radiation emitted by the sample to be examined as a consequence of the irradiation by the illumination radiation is referred to as emission radiation.

For example, light emitted by the sample to be examined as a consequence of the irradiation by the illumination or excitation light is referred to as emission light and reaches the detector, e.g. a camera, via the detection beam path. In order for the light to be able to be referred to as emission light, it is only necessary that the light is emitted by the illuminated sample or that in any case it comes from the illuminated sample. Typically, the emission light can be fluorescent light which is radiated or emitted by the sample, in particular dye molecules present there, as a consequence of the irradiation by the excitation light. The emission light can also be reflected, transmitted and scattered illumination light. The only requirement made in respect of the contrast-imparting principle is that the sample emits emission light as a consequence of the irradiation by the excitation light. The sample can also be referred to as a specimen.

The term illumination beam path denotes all, in particular optical, beam-guiding and beam-modifying components, e.g. lenses, mirrors, prisms, gratings, filters, stops, beam splitters, by means of which and via which the excitation radiation, in particular the excitation light, is guided from a radiation source, in particular a light source, to the sample to be examined. The illumination beam path can comprise an illumination objective. The illumination objective and a microscope objective can each be microscope objectives of a type known per se. In principle, the illumination objective and the microscope objective can also be separate objectives. However, in preferred embodiments, the illumination objective and the microscope objective are one and the same objective.

The term sample space denotes the spatial region in which a sample to be examined can be arranged. In typical embodiments, a sample, e.g. by means of a sample holder or a sample frame, can be positioned or secured on an x-y stage which is adjustable in lateral directions with respect to an optical axis. A z-drive can be present to change the distance between the sample stage and the illumination objective or between the sample and the microscope objective.

In principle, the sample can be any kind of sample. The methods and the optical device embodied as a microscope in the invention are suitable in particular for the examination of biological samples.

The light emitted by the sample to be examined as a consequence of the irradiation by the excitation light is referred to as emission radiation and in particular as emission light and reaches the detector, e.g. a camera, via the detection beam path. The term detection beam path is understood to mean all beam-guiding and beam-modifying, in particular optical, components, e.g. lenses, mirrors, prisms, gratings, filters, stops, beam splitters, by means of which and via which the emission radiation is guided from the sample to be examined as far as the camera. Expediently, a sensor plane of the detector can be arranged in a plane which is optically conjugate to a focal plane of the microscope objective.

The field of view of the detection beam path denotes the lateral spatial region in a sample plane from which emission radiation, in particular emission light, can be collected and forwarded to the detector. The size of the field of view is generally determined by the optical parameters, e.g. the aperture and magnification, of the microscope objective and of other components in the detection beam path, e.g. a tube lens.

The type of detector used to detect the emission radiation generally depends on the type of optical device and, in particular, the type of microscope. In embodiments of the inventions, the detector can comprise a two-dimensionally spatially resolving photodetector, e.g. a camera, a one-dimensionally spatially resolving detector, e.g. a linear detector arrangement, or a single photodetector, e.g. a point-type photodetector. Specifically, the detector can comprise at least one of the following elements or one of the following components: CCD element, CMOS element, SPAD element, PMT.

The mechanical drive for setting a relative lateral position between the sample and the microscope objective can be configured such that it moves the sample in relation to an optical axis, for example of a microscope objective, and/or is configured such that it moves the microscope objective and thus its optical axis in relation to the sample. The mechanical drive can be secured to a microscope stand. The microscope stand can be either an upright or an inverted stand.

The term control unit is understood to mean all hardware and software components that interact with the components of the optical device according to the invention for the intended functionality of the latter. In particular, the control unit can comprise a computing device, for example a PC, and a camera controller capable of reading out measurement signals. Measurement data of the detector are the measurement data generated by the detector upon the irradiation by emission light.

The term optical axis is taken to mean the optical axis of the imaging optical unit, in particular of the microscope objective, in the detection beam path.

Relative lateral position is taken to mean the lateral position of the sample relative to the optical axis. If, as usual, a coordinate system is chosen so that the optical axis coincides with the z-axis, the lateral coordinate directions are the x- and y-directions. The lateral coordinate directions are also taken to mean in particular those coordinate directions in which the tiles and the tiled image extend.

Overlapping tile images are taken to mean that the individual tiles do not adjoin one another with their edges, but rather overlap, in particular in both lateral coordinate directions. An overlap region of adjacent tile images is taken to mean that region of the lateral coordinates in which the adjacent tiles overlap.

The term unshaded sample images Bᵢ(x, y) denotes those sample images of the individual tiles that would theoretically be obtained if the shading artefacts described above were not present.

The shading function Sᵢ(x, y) and the additive shading term Tᵢ(x, y) for a specific tile i are scalar functions of the lateral coordinates. The support points are points in the plane of the tiles spanned by the lateral coordinates. Support points are taken to mean positions in a plane of the field of view. The correction factors are scalar values.

The present invention has firstly recognized that the shading artefacts described above can generally be modelled by mathematically comparatively simple types of model functions and model terms.

Furthermore, a basic concept of the invention described here can be considered that of ascertaining correction factors from the measurement data which allow uncomplicated fitting of the model function and the additive model term.

What can be considered to be an essential advantage of the invention is that at least spatially slowly variable shading artefacts can be corrected very well and moreover with little computational complexity, i.e. quickly.

The method according to the invention can be carried out by the optical device according to the invention. The method for microscopy according to the invention can be carried out by an optical device according to the invention embodied as a microscope. The optical device according to the invention, and in particular its control unit, can advantageously be configured to carry out the variants of the methods according to the invention described here.

In principle, it is possible for the method according to the invention also to encompass fitting of the additive shading term Tᵢ(x, y). In practice, however, it has proved to be sufficient to at least approximately determine the shading function Sᵢ(x, y). That means that in advantageous variants of the method according to the invention, zero can be chosen as model term for the additive shading term Tᵢ(x, y).

The model function can be defined by a plurality of parameters.

In a comparatively simple preferred variant of the method according to the invention, the model function is a function which is parabolic in the x-coordinate and/or a function which is parabolic in the y-coordinate.

In a more complex variant in which the shading functions can be fitted more accurately, however, the model function is a Zernike polynomial. For example, the model function can be a third-degree Zernike polynomial. In general, a function of an orthonormal function system can advantageously be chosen for the model function. Functions for which there is an orthonormal basis are well suited because the least-squares approximation can then be determined using simple scalar products. Examples of orthogonal function systems are: Zernike polynomials, two-dimensional Hermite polynomials, two-dimensional Laguerre polynomials, Jacobi polynomials. However, non-orthogonal polynomials can also be advantageous on account of their efficient evaluation capability owing to their polynomial character. For example, multivariate Bernstein polynomials can also be used because they allow a so-called shape-preserving approximation, preferably on simplices. Polynomials which are defined in principle on non-rectangular areas can also advantageously be used if the definition area comprises the relevant pixel region.

Particularly preferably, the model function is chosen such that the function value of the model function at the coordinate origin of the lateral coordinates, i.e. at the position (0,0), is 1. That means that it is assumed that there is no vignetting or other impairment of the propagated emission light on the optical axis and/or that the correction is normalized to 1 at the coordinate origin and that the corrections are thus carried out relative to the center, where no correction is effected.

In order to realize the method according to the invention, it is in principle only necessary for the support points at which the correction factors are calculated to lie within overlap regions of the tile images.

Preferably, the correction factors are calculated for support points which lie at edges of overlap regions of the tile images. In particular, the correction factors can advantageously be calculated for support points which lie on the coordinate axes. However, that is not absolutely necessary. The support points can also lie inside the overlap region.

For more complex model functions, it can be preferred to calculate the correction factors for a multiplicity of support points at points on the edge of a tile. For example, the support points can be localized in each case at equal distances on the edge of the tiles.

It is furthermore advantageous if a correction factor is calculated for at least one support point in each overlap region. It is also possible to calculate correction factors for support points which lie in regions of the tiles, and in particular on the edge of the tile, where the relevant tile overlaps a diagonally adjacent tile.

For tiles at the edge of the mosaic image where no overlap regions with adjacent tiles are present, correction factors obtained for support points at respective opposite edges can be used for the edges of the relevant tiles without adjacent tiles. Alternatively or supplementarily, for the edges of tiles at the edge of the mosaic image where no overlap regions with adjacent tiles are present, mean values of correction factors of tiles which are completely surrounded by other tiles can be used.

Using the model function and assuming that the measured tile images of adjacent tiles are structurally matched to one another, values of the sample image Bᵢ(x, y) can be calculated at support points on the coordinate axes and at the boundaries of the overlap regions. The correction factors can then be calculated as quotients of values of the tile images Cᵢ(x, y) and the values of the sample image Bᵢ(x, y) at support points on the coordinate axes and at the boundaries of the overlap regions. This alternative is considered especially if, as described above, a parabolic approach is chosen for the model function.

Supplementarily or alternatively, it is also possible for the correction factors to be quotients of values of the tile images measured from adjacent tiles.

In order to obtain even more information, it can be advantageous to insert additional support points in central regions of the tile images, wherein the function value of the model function at these additional support points is set to a suitable value, for example to 1. The additional support points can be advantageous if a model function with very many parameters is to be fitted.

The fitting of the shading functions and/or of the sample images, i.e. the actual fitting to the ascertained correction factors, can in principle be carried out using known methods. For example, it is possible for at least one of the shading functions and/or the sample images to be approximately determined using the correction factors with least squares fitting.

In one particularly preferred variant of the method according to the invention, in step d) approximately determining the shading function Sᵢ(x, y) and in step e) approximately determining the unshaded sample image Bᵢ(x, y) are each carried out iteratively by determining updated correction factors using in each case an (n−1)-th approximation of the shading function and/or an (n−1)-th approximation of the unshaded sample image, determining an n-th approximation of the shading function by fitting the correction factors to the respectively predefined model function, and determining an n-th approximation of the unshaded sample image using the n-th approximation of the shading function.

In this case, a number of free parameters for fitting at least one of the shading functions and/or the sample images may be higher in later iteration steps than at the beginning of the iteration.

In order to obtain a statement about a progress of the iteration, for a sample image of a tile i it is possible moreover to determine a distance between the n-th approximation of the sample images Bᵢⁿ(x, y) and the n−1-th approximation of the sample images Bᵢⁿ⁻¹(x, y). The iteration can then be continued if the distance is still greater than a threshold to be defined, and the iteration can be ended if the ascertained distance is less than the defined threshold. In principle, different mathematical norms can be used as a distance measure. For example, a Euclidean distance can be determined as a distance.

In order to reduce the computational complexity and to obtain a good approximation of the shading function more quickly, it can also be expedient to carry out the iterative method firstly for a model function for the shading function with a first number of free parameters and subsequently for a more complex model function with a second number of free parameters greater than the first number.

Finally, if an unshaded sample image of sufficient accuracy has been obtained for each of the tiles, the resulting unshaded sample images can be combined to form a mosaic image.

In principle, it is possible and also preferred for the shading function to be calculated at least approximately individually for each tile image.

For some situations, it can be expedient to calculate a mean value of the shading functions ascertained approximately individually for the tile images over the tiles. Consistency tests can then be carried out using this mean value. For example, a check can be made to establish how far an individual one of the approximately ascertained shading functions deviates from the ascertained mean value. An approximately ascertained shading function can be replaced by the mean value if it differs from the mean value by more than a threshold to be defined.

In order to reduce noise and compensate for outliers of pixels that are too bright or too dark, it is moreover preferred, for the calculation of the shading function, to evaluate values of the tile images not pixel-by-pixel, but rather for groups of a plurality of adjacent pixels. For example, for the pixels of these groups, a mean value or a median can be calculated and used for the further evaluation. Pixels that are too bright or too dark are also referred to as hot or cold pixels, respectively. Sometimes outliers are not only hot/cold pixels, but also given by the sample. If the sampling is high, taking account only of directly adjacent pixels may not be sufficient. In such cases, mean values and/or medians of pixels from a neighborhood can preferably be used. In this context, a plurality of pixels from a localized region around a central pixel can be used to obtain a representative value of the tile image at the central pixel by forming the mean value and/or the median. For example, the groups of pixels can each be localized in rectangular or square regions. For example, an edge length of the rectangular or square regions can be between 2% and 5% and preferably 3% of the overlap between adjacent tiles.

Further advantages and features of the present invention are explained below in association with the figures, in which:

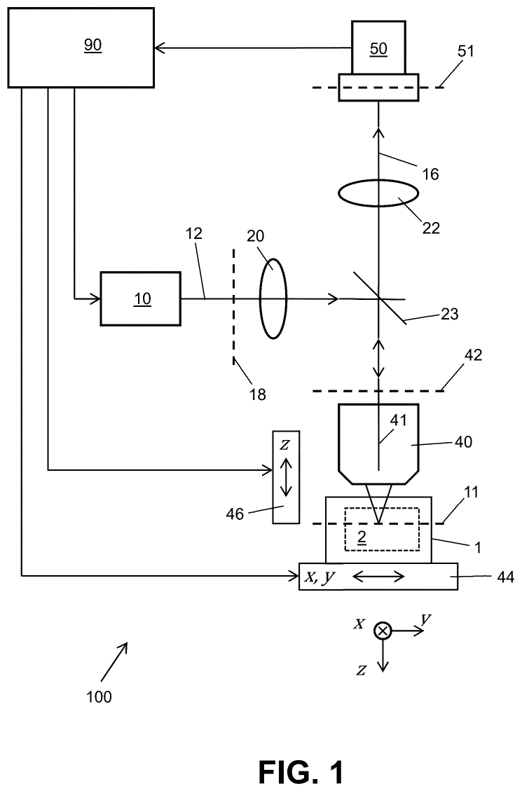

FIG. 1: shows a schematic illustration of one exemplary embodiment of an optical device according to the invention;

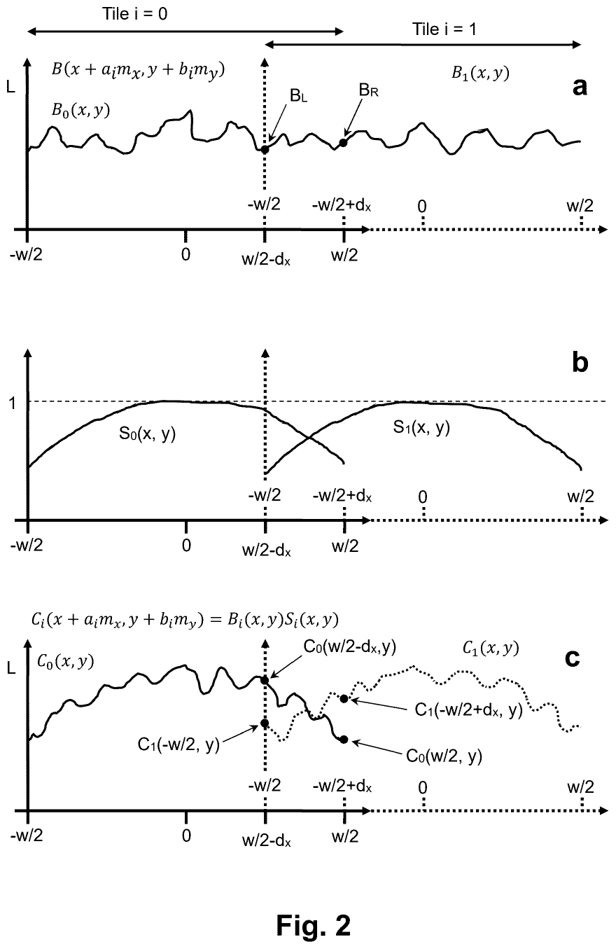

FIG. 2: shows diagrams for explaining a first exemplary embodiment of the method according to the invention;

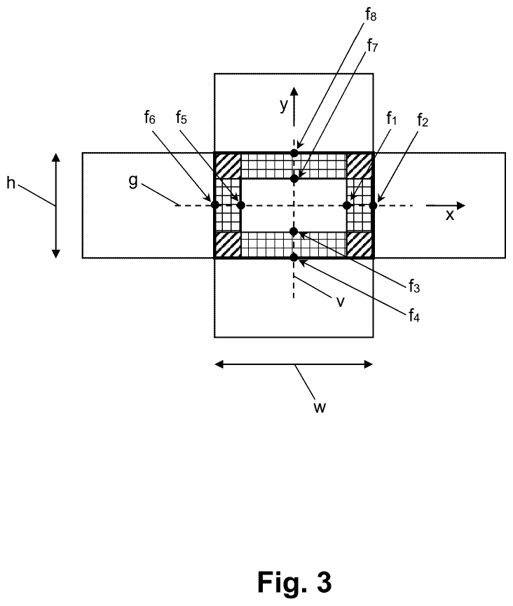

FIG. 3: shows a schematic illustration of overlapping tiles for explaining the first exemplary embodiment of the method according to the invention;

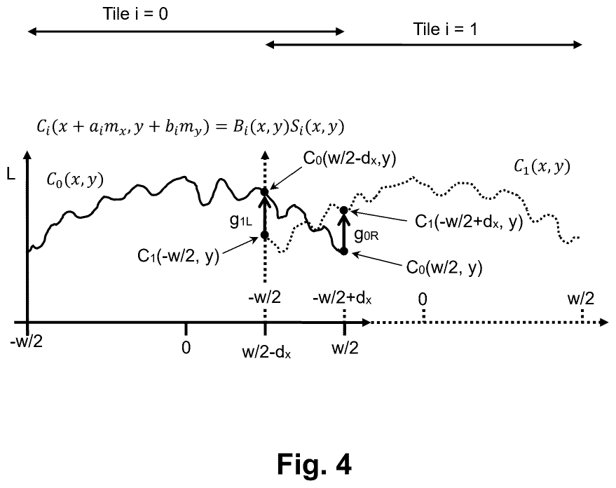

FIG. 4: shows a diagram for explaining a second exemplary embodiment of the method according to the invention, and

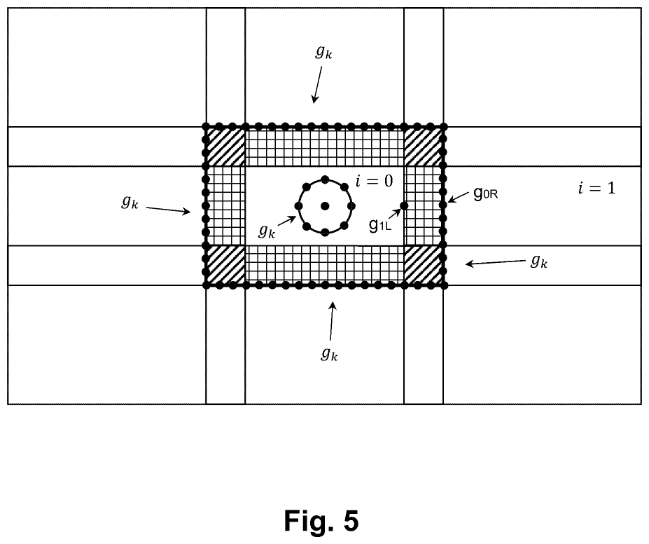

FIG. 5: shows a further schematic illustration of overlapping tiles for explaining the second exemplary embodiment of the method according to the invention.

Identical and identically acting components are generally provided with the same reference signs in the figures.

One embodiment of an optical device according to the invention, which is embodied as a microscope 100, is described with reference to FIG. 1.

The microscope 100 firstly comprises a light source 10, e.g. a laser, for providing illumination light 12 and an illumination beam path for guiding the illumination light 12 to a sample space 1. In the example shown, the illumination beam path comprises a tube lens 20, a main beam splitter 23 and a microscope objective 40. The tube lens 20 generates an intermediate image plane 18, i.e. a plane which is optically conjugate to a plane 11 in a sample 2 in the sample space 1. In the illumination beam path, the excitation light 12 passes through the intermediate image plane 18 and via the tube lens 20 to the main beam splitter 23 and is reflected there in the direction of the microscope objective 40. The excitation light 12 then passes through a back focal plane 42 of the microscope objective 40 and is subsequently directed from the microscope objective 40 into the sample space 1. The sample 2 can be a biological sample and be prepared with fluorophores which can be excited by the excitation light 12. The wavelength and intensity of the excitation light 12 can be chosen suitably with regard to the sample 2 and the fluorophores used. The light source 10 can consist of a multiplicity of different lasers. The wavelength and/or intensity can be settable.

Furthermore, the microscope 100 comprises a detector 50 for detecting emission light 16 emitted by a sample 2 in the sample space 1, and a detection beam path having a microscope objective 40 for guiding the emission light 16 to the detector 50. In the example shown, the microscope 100 is a wide-field microscope and the detector 50 is a camera, i.e. a field of view 30 (FOV) of the detection beam path is imaged onto a sensor plane 51 of the camera 50. The sensor plane 51 is optically conjugate to the plane 11 in the sample space 1.

The emission light 16 emitted by the sample 2 can typically be red-shifted fluorescent light emitted by the fluorophores in the sample 2. The main beam splitter 23 is configured to transmit the red-shifted emission light 16 and reflect the excitation light 12, thereby preventing large portions of the excitation light 12 backscattered from the sample space 1 from being able to pass in the direction of the camera 50.

In the detection beam path, the emission light 16 emitted by the sample 2 is received by the microscope objective 40, passes through the main beam splitter 23 and is then imaged by a tube lens 22 into the sensor plane 51 of the camera 50.

As known in the prior art, an excitation filter can be present in the excitation beam path, e.g. between the tube lens 20 and the main beam splitter 23, and/or an emission filter can be present in the detection beam path, e.g. between the tube lens 22 and the main beam splitter 23. A plurality of different main beam splitters 23 are also possible, which are coordinated with individual fluorophores and can be switched into the beam path.

Furthermore, the microscope 100 comprises a, in particular automated, mechanical drive 44 for setting a relative lateral position x, y between the sample 2 and the microscope objective 40 with respect to an optical axis 41 of the microscope objective 40 and a control unit 90, e.g. a PC, which is configured for controlling the mechanical drive 44 and for acquiring and evaluating measurement data from the detector 50. In the example shown, the optical axis 41 of the microscope objective 40 extends in the direction of the z-axis. The mechanical drive 44 can be e.g. part of a motorized sample stage and, in the example shown, serves to set a predefined position of the sample 2, i.e. predefined x-, y-coordinates of the sample 2 with respect to the optical axis 41. A right-handed and orthogonal coordinate system x, y, z is illustrated below the mechanical drive 44. In the example shown, the microscope 100 furthermore comprises an axial drive 46, which is used to set a predefined axial distance, i.e. a distance in the z-direction between the sample 2 and the microscope objective 40.

The exemplary embodiment shown of the microscope according to the invention is additionally configured to carry out the method according to the invention. For this purpose, the control unit 90 is configured according to the invention to carry out the following method steps for ascertaining unshaded sample images Bᵢ(x, y):
a) predefining an approach (S103)
   Cᵢ(x, y)=Sᵢ(x, y)Bᵢ(x, y)+Tᵢ(x, y) for the measured tile images Cᵢ(x, y), in which Bᵢ(x, y) is an unshaded sample image to be ascertained of a tile i, Sᵢ(x, y) is a shading function for the tile i, and
   Tᵢ(x, y) is an additive shading term for the tile i;
b) predefining (S104; S204) a model function (P(x, y), Fᵢ(x, y); Gᵢ(x, y)) for the shading function Sᵢ(x, y) and a model term for the additive shading term Tᵢ(x, y),
c) determining correction factors (fₖ; gₖ; S105, S205) at a plurality of support points ((xᵢ, yᵢ), (xⱼ, yⱼ)) in an overlap region of adjacent tile images (Cᵢ(x, y), Cⱼ(x, y)) using the tile images Cᵢ(x, y),
d) at least approximately determining (S108; S207) the shading function Sᵢ(x, y) and the shading term Tᵢ(x, y) by fitting the model function (P(x, y); Fᵢ(x, y); Gᵢ(x, y)) predefined in step b) to the correction factors (fₖ; gₖ), determined in step c)
e) approximately determining (S109; S208) an unshaded sample image Bᵢ(x, y) using the shading function Sᵢ(x, y) at least approximately determined in step d) and the at least approximately determined shading term Tᵢ(x, y).

A first exemplary embodiment of the method according to the invention is explained with reference to method steps S101 to S118 presented hereinbelow and with reference to FIGS. 2 and 3.

FIG. 2 shows respective diagrams for a first tile i=0 and a second tile i=1. The coordinate systems are illustrated in each case using solid lines for the first tile i=0 and in each case using dashed lines for the second tile i=1. The diagrams a at the top of FIG. 2 show the intensities of the sought sample images B₀(x, y), B₁(x, y) as a function of the x-coordinate. It should be taken into account that the x-coordinate relates in each case to the centre of the respective tile. The diagrams b in the middle of FIG. 2 respectively show the shading function S₀(x, y), S₁(x, y) to be determined. The diagrams c at the bottom of FIG. 2 show the data C₀(x, y), C₁(x, y) respectively measured for the first tile i=0 and the second tile i=1.

FIG. 3 shows five rectangular tiles of equal size, which each have a width b and a height h and which are arranged in a rectangular grid. Those regions in which the central tile overlaps one adjacent tile are illustrated with chequered hatching. The regions in which the central tile overlaps two adjacent tiles are illustrated with obliquely lined hatching. The directions of the x-coordinate and the y-coordinate are additionally plotted in FIG. 3. The midpoint of the central tile lies at the origin of the coordinate system. The horizontal line g runs along the x-direction and divides the central tile horizontally in the middle. The vertical line v in FIG. 3 runs along the y-direction and divides the central tile vertically in the middle. Support points at which correction factors are calculated are indicated schematically in FIG. 3 by thick black dots. This will be described in detail below.

### Method #1

S101 Collecting measurement data using microscope
S102 Matching the measurement data of respective adjacent tiles (“stitching”) result Cᵢ (x, y), i=0, . . . , N−1
S103
S104

$$Approach {C}_{i} ( x , y ) = {B}_{i} ( x , y ) {S}_{i} ( x , y )$$

$$Approach {S}_{i} ( x , y ) \approx {P}_{i} ( x , y ) = 1 + {p}_{1} x + {p}_{2} {x}^{2} + {p}_{3} y + {p}_{4} {y}^{2}$$

S105 Determining correction factors according to

$$equ . 1 : {f}_{k = 1} ( {x}_{k} , {y}_{k} ) = {C}_{k} ( {x}_{k} , {y}_{k} ) / {B}_{L} ( {x}_{k} , {y}_{k} ) ,$$

$$equ . 2 : {f}_{k = 2} ( {x}_{k} , {y}_{k} ) = {C}_{k} ( {x}_{k} , {y}_{k} ) / {B}_{R} ( {x}_{k} , {y}_{k} ) , et cetera$$

wherein B_{L} and B_{R} can be calculated according to equ. 3 and equ. 4 (see explanation below). Overall, 8 correction factors fₖ for a tile not located at the edge can be ascertained in this way for the other tiles overlapping in the x- and y-directions (see FIG. 3).
S106 Approach for the shading function:

$${S}_{i} ( x , y ) \approx {F}_{i} ( x , y ) = 1 + {a}_{i} x + {b}_{i} {x}^{2} + {c}_{i} y + {d}_{i} {y}^{2}$$

S107 Setting an index n of the approximation of the shading function Fᵢ(x, y) and the approximation of the sought sample image

$${B}_{i}^{n} ( x , y ) to n = 1$$

S108 Determining a first approximation of the shading function

$${F}_{i}^{1} ( x , y )$$

by fitting, for example using the least squares method, of Fᵢ(x, y) to the correction factors fₖ ascertained in step S105;
result:

$${F}_{i}^{1} ( x , y )$$

S109 Determining a first approximation of the sought sample image

$${B}_{i}^{1} ( x , y )$$

by inserting the shading function

$${F}_{i}^{1} ( x , y )$$

approximately determined in S108 as Sᵢ(x, y) into the approach from S103:

$${B}_{i}^{1} ( x , y ) = {C}_{i} ( x , y ) / {F}_{i}^{1} ( x , y )$$

S110 Increasing n by 1
S111 Determining updated correction factors fₖ as in step S105 using

$${B}_{i}^{n - 1} ( x , y ) for {C}_{i} ( x , y ) and {F}_{i}^{n - 1} ( x , y ) for {S}_{i} ( x , y )$$

S112 Determining the n-th approximation of the shading function

$${F}_{i}^{n} ( x , y )$$

by fitting, for example using the least squares method, of a curve of the type predefined in S106 to the updated correction factors fₖ ascertained in S111; result:

$${F}_{i}^{n} ( x , y )$$

S113 Determining the n-th approximation of the sample image

$${B}_{i}^{n} ( x , y )$$

by inserting

$${F}_{i}^{n} ( x , y ) from S 112 into {B}_{i}^{n} ( x , y ) = {B}_{i}^{n - 1} ( x , y ) / {F}_{i}^{n} ( x , y )$$

S114 Determining the, for example Euclidean, distance d between

$${B}_{i}^{n} ( x , y ) and {B}_{i}^{n - 1} ( x , y ) :$$

S115 if d is greater than threshold S to be defined: continue at S110
S116 if d is less than defined threshold S:
S117 Carrying out steps S103 to S116 for all tiles i
S118 Combining the respective current approximations for the Bᵢ(x, y) to form B(x′, y′): result: B(x′, y′)

Firstly, in step S101, measurement data, namely the image data from the detector 50 for the individual tiles i where i=0, . . . , N−1, are collected using the microscope, for example the microscope 100 according to the invention from FIG. 1.

Then, in step S102, the measurement data in the respective overlap regions of the individual tiles are structurally matched to one another. That corresponds to the process of “stitching”. The data sets thus obtained are referred to as measured tile images Cᵢ(x, y). The coordinate x therein denotes a discrete integer position x of a pixel within a tile image in the x-direction, and the coordinate y denotes a discrete integer position y of a pixel within a tile image in the y-direction. The following approach is then written for Cᵢ (x, y):

$${C}_{i} ( x , y ) = {B}_{i} ( x , y ) {S}_{i} ( x , y ) + {T}_{i} ( x , y ) .$$

In the latter, Bᵢ(x, y) is the brightness generated by the sample at the tile position (x, y) without shading effects, Sᵢ(x, y) is the shading function, i.e. a multiplicative shading effect at the tile position (x, y) caused e.g. by vignetting and/or contamination on the detector, and Tᵢ(x, y) is the additive shading term, i.e. an additive shading effect at the tile position (x, y).

The invention has recognized that generally all shading effects can be represented by a multiplicative shading effect, hence by the shading function Sᵢ(x, y). The approach thus becomes simplified (step S103) to

$${C}_{i} ( x , y ) = {B}_{i} ( x , y ) {S}_{i} ( x , y )$$

The image composed of the tiles is referred to as a mosaic image. Without restricting generality, it can be assumed that the mosaic image is composed of N overlapping tiles, each of the same size, which are arranged on a regular grid. For example, the index i of the tiles thus runs from 0 to N−1. The i-th tile is displaced relative to the global coordinate origin by a relative displacement vector mᵢ=(αᵢmₓ, βᵢm_{y}) where αᵢ,βᵢ∈ [symbol] ₀, mₓ<w and m_{y}<h, wherein w is the width and h is the height of the tiles.

The overlap of the tiles in the horizontal direction, i.e. the x-direction, is thus dₓ=w−mₓ and the overlap of the tiles in the vertical direction, i.e. the y-direction, is d_{y}=h−m_{y}. Typically, the tiles can have an overlap of 10%. In this case, mₓ=0.9w and m_{y}=0.9h. A global position (x′, y′) in the mosaic image can thus be written as

$$( {x}^{′} , {y}^{′} ) = ( x + {α}_{i} {m}_{x} , y + {β}_{i} {m}_{y} )$$

The brightness of the mosaic image Cᵢ(x′, y′) measured by the detector can be written as

$${C}_{i} ( {x}^{′} , {y}^{′} ) = C ( x + {α}_{i} {m}_{x} , y + {β}_{i} {m}_{y} )$$

The shading function Sᵢ(x, y) is in principle different for each individual tile. Since the essential contributions to Sᵢ(x, y) are each given by the optical characteristics of the illumination and detection beam paths, however, Sᵢ(x, y) is generally similar for the individual tiles.

A typical situation is explained below with reference to FIG. 2. As can be seen from FIG. 2, the following four equations (I) to (IV) can be formulated.

$${C}_{0} ( \frac{w}{2} - {d}_{x} , y ) = {B}_{0} ( \frac{w}{2} - {d}_{x} , y ) {S}_{0} ( \frac{w}{2} - {d}_{x} , y ) \qquad ( I )$$

$${C}_{1} ( - \frac{w}{2} , y ) = {B}_{1} ( - \frac{w}{2} , y ) {S}_{1} ( - \frac{w}{2} , y ) \qquad ( II )$$

$${C}_{0} ( \frac{w}{2} , y ) = {B}_{0} ( \frac{w}{2} , y ) {S}_{0} ( \frac{w}{2} , y ) \qquad ( III )$$

$${C}_{1} ( - \frac{w}{2} + {d}_{x} , y ) = {B}_{1} ( - \frac{w}{2} + {d}_{x} , y ) {S}_{1} ( - \frac{w}{2} + {d}_{x} , y ) \qquad ( IV )$$

In each of equations (I) to (IV), the values of the variables C on each left side are known by way of measurement using the detector for the tiles i=0 and i=1. The values of the variables on each right side of equations (I) to (IV) are unknown and are therefore sought.

The following further conditions (V) and (VI) result from the further condition that adjacent tile images, as described above, are structurally matched to one another (“stitched”):

$${B}_{0} ( \frac{w}{2} - {d}_{x} , y ) = {B}_{1} ( - \frac{w}{2} , y ) := {B}_{L} \qquad ( V )$$

$${B}_{0} ( \frac{w}{2} , y ) = {B}_{1} ( - \frac{w}{2} - {d}_{x} , y ) = {B}_{R} \qquad ( VI )$$

Equations (V) and (VI) reduce the number of eight unknown parameters B and S to six unknown parameters.

In this embodiment variant of the method according to the invention, according to step S104 the following parabolic approach is used for the shading function S(x, y):

S(x, y)≈P(x, y)=1+p₁x+p₂x² p₃y+p₄ y² In the centre of the image (x, y)=(0,0), it is the case that P(x, y)=P(0,0)=1. The approach therefore assumes that the brightness value is not disturbed at the centre of each tile. That is generally a good assumption. Moreover, the same shading function P(x, y) is assumed here initially for the tiles i=0 and i=1. Nevertheless, in general, the algorithm for the tile i and the tile j can and will provide different approximated shading functions, since the least square fit for the tiles i and j as explained in detail hereinafter is influenced in each case by different correction factors from the respective left and right image overlaps.

If firstly y=0 is set in this model, the two parameters p₁ and p₂ are still free and therefore to be determined. Using this model, the number of unknown parameters for equations (I), (II), (III), (IV) is reduced from six to four, so that the following system of equations for the four unknown parameters

$${p}_{1} , {p}_{2} , {B}_{0} ( \frac{w}{2} - {d}_{x} , 0 ) = {B}_{L} and {B}_{0} ( \frac{w}{2} , y ) = {B}_{R}$$

can be solved.

$${C}_{0} ( \frac{w}{2} - {d}_{x} , 0 ) = {B}_{L} P ( \frac{w}{2} - {d}_{x} , 0 )$$

$${C}_{1} ( - \frac{w}{2} , 0 ) = {B}_{L} {P}_{1} ( - \frac{w}{2} , 0 )$$

$${C}_{0} ( \frac{w}{2} , 0 ) = {B}_{R} {P}_{0} ( \frac{w}{2} , 0 )$$

$${C}_{1} ( - \frac{w}{2} + {d}_{x} , 0 ) = {B}_{R} P ( - \frac{w}{2} + {d}_{x} , 0 )$$

With the following variables introduced for reasons of greater clarity of representation:

$${I}_{1} : = {C}_{0} ( \frac{w}{2} - {d}_{x} , 0 )$$

$${I}_{2} : = {C}_{1} ( - \frac{w}{2} , 0 )$$

$${I}_{3} : = {C}_{0} ( \frac{w}{2} , 0 )$$

$${I}_{4} : = {C}_{1} ( - \frac{w}{2} + {d}_{x} , 0 )$$

the following is obtained as the result for B_{L} at the left tile edge and B_{R} at the right tile edge:

$${B}_{L} = \frac{8 {I}_{2} {I}_{3} {d}_{x}^{3} - 2 {I}_{2} {I}_{4} w {d}_{x}^{2} - 12 {I}_{2} {I}_{3} w {d}_{x}^{2} - 2 {I}_{1} {I}_{3} w {d}_{x}^{2} {w}^{3}}{4 {d}_{x} ( {d}_{x} - w ) ( 2 {I}_{3} {d}_{x} - {I}_{4} w - {I}_{3} w )} ++ \frac{{I}_{2} {I}_{4} {w}^{2} {d}_{x} + 6 {I}_{2} {I}_{3} {w}^{2} {d}_{x} + {I}_{1} {I}_{3} {w}^{2} {d}_{x} + {I}_{1} {I}_{4} {w}^{3} - {I}_{2} {I}_{3} {w}^{3}}{4 {d}_{x} ( {d}_{x} - w ) ( 2 {I}_{3} {d}_{x} - {I}_{4} w - {I}_{3} w )} \qquad equ . 3$$

$$and$$

$${B}_{R} = \frac{8 {I}_{2} {I}_{3} {d}_{x}^{3} - 2 {I}_{2} {I}_{4} w {d}_{x}^{2} - 12 {I}_{2} {I}_{3} w {d}_{x}^{2} - 2 {I}_{1} {I}_{3} w {d}_{x}^{2}}{4 {d}_{x} ( {d}_{x} - w ) ( 2 {I}_{2} {d}_{x} - {I}_{2} w - {I}_{1} w )} ++ \frac{{I}_{2} {I}_{4} {w}^{2} {d}_{x} + 6 {I}_{2} {I}_{3} {w}^{2} {d}_{x} + {I}_{1} {I}_{3} {w}^{2} {d}_{x} + {I}_{I} {I}_{4} {w}^{3} - {I}_{2} {I}_{3} {w}^{3}}{4 {d}_{x} ( {d}_{x} - w ) ( 2 {I}_{2} {d}_{x} - {I}_{2} w - {I}_{1} w )} \qquad equ . 4$$

Analogously, it is possible to calculate B_{L} and B_{R} for x=0 and thus in the vertical direction. With these results, correction factors can now be calculated for support points on the coordinate axes and at the respective boundaries of the overlap regions. These support points are highlighted by thick black dots in FIG. 3. For these points, the correction factors can be calculated as already described in step 105:

$${f}_{k = 1} ( {x}_{k} , {y}_{k} ) = {C}_{k} ( {x}_{k} , {y}_{k} ) / {B}_{L} ( {x}_{k} , {y}_{k} ) \qquad {f}_{k} ( equ . 1 )$$

$${f}_{k = 2} ( {x}_{k} , {y}_{k} ) = {C}_{k} ( {x}_{k} , {y}_{k} ) / {B}_{R} ( {x}_{k} , {y}_{k} ) \qquad {f}_{k} ( equ . 2 )$$

in which k is a running index of the support points (see situation in FIG. 3). It is important that these results apply regardless of whether the image shows the background or the sample at the specified positions. One restriction, however, is that none of these positions should contain overexposed or black pixels. For the horizontal line g running through the middle of the tile, i.e. at y=0, and for the vertical line h running through the middle of the tile, i.e. at x=0, that can be carried out for all pairs of adjacent tiles, so that corresponding correction factors result at a total of 8 support points.

In step S106, the parabolic approach Sᵢ(x, y)≈Fᵢ(x, y)=1+aᵢx+bᵢx²+cᵢy+dᵢy² is then chosen for the shading function Sᵢ(x, y) to be determined.

The total of 8 correction factors at the respective eight positions are then used in step S108 to determine a first approximation

$${F}_{i}^{1} ( x , y )$$

of the shading function Fᵢ(x, y) by means of least squares fitting. Each of the positions marked in FIG. 3 provides a respective correction factor. At the same positions, correction factors likewise result for the adjacent tile, but these are used to determine the approximation of the shading function of the adjacent tile. Thus, for the four parameters of the parabolic approach a, b, c, d of the i-th tile, eight input values are available and are used for the least square fit.

With

$${F}_{i}^{1} ( x , y )$$

subsequently in step S109 a first approximation

$${B}_{i}^{1} ( x , y )$$

for the sought sample image

$${B}_{i}^{1} ( x , y )$$

is calculated as follows:

$${B}_{i}^{1} ( x , y ) = {C}_{i} ( x , y ) / {F}_{i}^{1} ( x , y )$$

Although a very simple model function is used here, it generally compensates for or reduces most of the slowly varying shading artefacts. The index i indicates that the function Fᵢ(x, y) for each tile i is fundamentally different. The computational complexity is comparatively low in comparison with pixelwise iterative optimization of cost functions, which are used for example in [Lötgering]. It is therefore possible relatively straightforwardly to calculate and use the shading correction function Fᵢ(x, y) for each tile individually. In many cases, however, the functions Fᵢ(x, y) calculated for the various tiles will be comparatively similar. It can therefore be useful to calculate an averaged function [symbol] Fᵢ(x, y) [symbol] from the totality of the functions Fᵢ(x, y). Furthermore, consistency checks can be carried out to establish whether the result of an individual Fᵢ(x, y) deviates to a particularly great extent for example from the other Fᵢ(x, y) or from the averaged function [symbol] Fᵢ(x, y) [symbol] . In particular, overexposed or very dark pixels can be taken into account.

The calculation of the approximation of the shading function Fᵢ(x, y) for tiles at the left, right, top or bottom edge of the mosaic image is complicated by the lack of neighbouring tiles. However, since the functions Fᵢ(x, y) are generally similar, the calculation for these tiles can be supported by using for each of the correction factors either values mirrored by opposite tile boundaries or averaged values of tiles completely surrounded by other tiles.

From a mathematical standpoint, the functions Fᵢ(x, y) could be calculated from the brightness values of the respective individual pixels. However, it should be taken into account that the brightness value of an individual pixel is influenced by noise, and that it is moreover necessary for the tiles to be structurally matched to one another correctly, and thus correctly merged (“stitched”). That is to say that superimposed luminance or brightness values of the pixels must originate from exactly the same sample region. These circumstances may complicate the calculations. The influence of both problems, i.e. noise and being correctly merged, can be reduced by using spatially averaged brightness values for Cᵢ(x, y) for calculating the approximation of the shading function Fᵢ(x, y), e.g. by calculating averaged brightness values within small regions. This averaging process also makes it possible to identify and exclude overexposed or excessively dark pixels, or at least to reduce their effect. Alternatively, a median of the respective measurement values can also be calculated from the pixels in the small regions or environments.

It is important that the correction method described here for the theoretical case that a shading has exactly the same parabolic profile P(x, y) for all tiles ideally describes the shading artefacts and thus enables the sought undisturbed brightness values of the sample Bᵢ(x, y) to be calculated directly.

Since the shading in real cases does not have an exactly parabolic profile, it is expedient to iteratively determine the approximation of the shading function Fᵢ(x, y) and thus the sample image Bᵢ(x, y). This is explained with reference to method steps S110 to S116.

Firstly, in step S110, the index n is increased by 1. Updated correction factors are then determined in step S111. This is done in principle as described above with the proviso that instead of Cᵢ(x, y) use is made of the last determined approximation, i.e. the (n−1)-th approximation of the sample image

$${B}_{i}^{n - 1} ( x , y ) ,$$

and instead of Cᵢ(x, y) use is made of the last determined approximation, i.e. the (n−1)-th approximation of the shading function

$${F}_{i}^{n - 1} ( x , y ) for {S}_{i} ( x , y ) .$$

Using the updated correction factors fₖ ascertained in step S111, an n-th approximation of the shading function

$${F}_{i}^{n} ( x , y )$$

is subsequently ascertained in step S112 by fitting a curve of the type predefined in step S106. This n-th approximation of the shading function

$${F}_{i}^{n} ( x , y )$$

can then be used in step S113 to calculate an n-th approximation of the sample image

$${B}_{i}^{n} ( x , y ) ,$$

as follows:

$${B}_{i}^{n} ( x , y ) = {B}_{i}^{n - 1} ( x , y ) / {F}_{i}^{n} ( x , y ) .$$

For numerical stabilization and/or if the denominator in this equation becomes zero for a specific pixel, divisions of the form a/b can be executed in a regularized manner as: a/b=a*b/(b²+e) with a small regularization parameter e.

In order to check a progress of the iteration, in step S114 it is then possible to calculate a distance d, using for example a Euclidean metric, between

$${B}_{i}^{n} ( x , y ) and$$

$${B}_{i}^{n - 1} ( x , y ) .$$

If a check reveals that the distanced is still greater than a threshold S to be defined (step S115), the iteration is continued at step S110. However, if the check reveals that the distance d is less than the defined threshold S (step S116), the iteration is terminated. The intermediate result then present for the tile i is the current approximation of the sample image

$${B}_{i}^{n} ( x , y )$$

with an accuracy set by the defined threshold S. In accordance with step S117, then steps S103 to S116 described here are carried out for all tiles i and, in step S118, the respective current approximations for the Bᵢ(x, y) are then combined to form B(x′, y′).

The explanations above make it clear that more complex functions can in principle also be used for approximating Bᵢ(x, y) if more support points for sampling the brightness values in the overlap regions and thus more correction factors are taken into account. Each additional correction factor allows the formulation of two further equations with a new unknown value for Bᵢ(x, y) at the relevant support point, which enables a further parameter of the model function. However, the resulting equations can be complicated for model functions with more free parameters.

Hereinafter, a second exemplary embodiment of the method according to the invention is described, which allows the use of more complex model functions Gᵢ(x, y), which requires only a small number of iterations and in which the background of a tile image does not have to be separated from sample regions. The model function Gᵢ(x, y) for the shading function can be defined by Zernike polynomials, for example. For example, 10 free parameters would have to be fitted for third-degree Zernike polynomials.

The second exemplary embodiment of the method according to the invention is explained with reference to method steps S201 to S217 presented hereinbelow and with reference to FIGS. 4 and 5. The diagram in FIG. 4 corresponds to the diagram c from FIG. 2, i.e. it shows the data C₀(x, y), C₁(x, y) respectively measured for a first tile i=0 and a second tile i=1.

FIG. 5 shows nine rectangular tiles, each of equal size. The size and arrangement of these tiles correspond to those of each of the tiles from FIG. 3. The hatchings in the overlap regions are the same as in FIG. 3. In FIG. 5, too, support points at which correction factors are calculated are indicated by thick black dots. This will be described in detail below.

### Method #2

S201 Collecting measurement data using microscope
S202 Matching the measurement data of respective adjacent tiles (“stitching”) result
S203
S204

$${C}_{i} ( x , y ) , i = 1 , … , N$$

$$Approach {C}_{i} ( x , y ) = {B}_{i} ( x , y ) {S}_{i} ( x , y )$$

$$Approach {S}_{i} ( x , y ) \approx {G}_{i} ( x , y ) {G}_{i} ( x , y ) with {G}_{i} ( x , y )$$

Zernike polynomial
S205 Determining correction factors

$$equ . 5 : {g}_{k} = {C}_{i} ( {x}_{i} , {y}_{i} ) / {C}_{j} ( {x}_{j} , {y}_{j} )$$

for a specific tile i for points at the edges of the overlap regions (FIG. 5), wherein j identify the tiles adjacent to tile i
S206 Setting the index n of the approximation of a shading function

$${G}_{i}^{n} ( x , y )$$

and the approximation of the sought sample image

$${B}_{i}^{n} ( x , y ) to n = 1$$

S207 Determining a first approximation of the shading function

$${G}_{i}^{1} ( x , y )$$

by fitting, for example using the least squares method, of Gᵢ(x, y) to the correction factors g ascertained in S205;
result:

$${G}_{i}^{1} ( x , y )$$

S208 Determining a first approximation of the sought sample image

$${B}_{i}^{1} ( x , y )$$

by inserting the shading function

$${G}_{i}^{1} ( x , y )$$

approximately determined in S207 as Sᵢ(x, y) into the approach from S204:

$${B}_{i}^{1} ( x , y ) = {C}_{i} ( x , y ) / {G}_{i}^{1} ( x , y )$$

S209 Increasing n by 1
S210 Determining updated correction factors gₖ as in S205 using

$${B}_{i}^{n - 1} ( x , y ) for {C}_{i} ( x , y )$$

S211 Determining the n-th approximation of the shading function

$${G}_{i}^{n} ( x , y )$$

by fitting, for example using the least squares method, of a curve of the type predefined in step S104 to the updated correction factors g ascertained in S211; result:

$${G}_{i}^{n} ( x , y )$$

S212 Determining the n-th approximation of the sample image

$${B}_{i}^{n} ( x , y )$$

by inserting

$${G}_{i}^{n} ( x , y ) from S 211 into {B}_{i}^{n} ( x , y ) = {B}_{i}^{n - 1} ( x , y ) / {G}_{i}^{n} ( x , y )$$

S213 Determining the, for example Euclidean, distance d between

$${B}_{i}^{n} ( x , y ) and {B}_{i}^{n - 1} ( x , y ) :$$

S214 if d is greater than threshold S to be defined: continue at S209
S215 if d is less than defined threshold S:
S216 Carrying out steps S203 to S215 for all tiles
S217 Combining the respective current approximations for the Bᵢ(x, y) to form B(x′, y′): result: B(x′, y′)

Steps S201 to S203 correspond identically to steps S101 to S103 of the first method variant described above. In step S204, a Zernike polynomial, for example a 3rd-degree Zernike polynomial, is chosen as the model function for the shading function Sᵢ(x, y). Expediently, the definition range of the Zernike polynomial is suitably chosen and/or the correction values are suitably normalized in order to be able to describe a rectangular shading function, which thus corresponds to the measured image, as values of a Zernike polynomial. For example, the radial term components of the Zernike polynomial can be normalized to the length of the image diagonal.

In step S205, correction factors g=Cᵢ(xᵢ, yᵢ)/Cⱼ(xⱼ, yⱼ) are then determined for points at the edges of the overlap regions. These points are illustrated schematically by thick black dots for the central tile in FIG. 5. The calculation of these correction factors is explained by way of example with reference to the diagram in FIG. 4. For the left tile i=0, at the position (w/2, y) it is possible to calculate a correction factor g_{0R} at the right tile edge as

$${g}_{0 R} = {C}_{1} ( - w / 2 + {d}_{x} , y ) / {C}_{0} ( w / 2 , y )$$

This correction factor is designed such that by multiplication by the brightness value of the pixel at the boundary position, the brightness value thereof is corrected such that it corresponds to the brightness value of the overlapping tile at the same position. This is indicated by an arrow in FIG. 4.

Correspondingly, for the right tile i=1 it is possible to calculate a correction factor g_{1L} at the left tile edge as

$${g}_{1 L} = {C}_{1} ( w / 2 - {d}_{x} , y ) / {C}_{1} ( - w / 2 , y )$$

The effect of the correction factors g_{1L} and g_{0R} is illustrated in each case by a vertical arrow in FIG. 4. The support points of the correction factors g_{0R} and g_{1L} are additionally shown in FIG. 5. It is important that g_{0R} and g_{1L} are examples of the correction factors gₖ. The indices 0R and 1L are intended to serve here as an indication of the respective locations of the support points.

Such correction factors g can then be calculated for many y-positions along the vertical boundaries of the overlapping tiles. Analogously, corresponding values can also be calculated for the horizontal boundaries. The support points for which these correction factors are calculated for the central tile are illustrated by black dots in FIG. 5. As with method variant #1, it is useful for the robustness of the calculation to use spatially averaged brightness or luminance values, i.e. brightness or luminance values averaged over a plurality of pixels.

It is also possible to add correction factors at positions of diagonal tiles. These overlap regions are illustrated with obliquely lined hatching in FIG. 5. Furthermore, it is possible to add additional correction factors that do not lie at the tile edges. For example, it is possible to add one or more correction factors with the value of 1.0 at or near the center of the tile. That means that the function values of the model function at these points should tend towards these additional correction factors with progressive iteration.

If the number of calculated correction factors is greater than the number of free parameters of the model function that are to be fitted, the model function can be determined by way of least squares fitting. The model function can then be used to determine correction factors for all pixels within the tile. By applying these correction factors to the brightness values Cᵢ(xᵢ, yᵢ), it is possible to reduce the remaining brightness deviations at the tile boundaries. This affords the advantage that such fitting of the brightness values takes place in a natural manner over the entire tile region. Therefore, it is possible to achieve a good correction of the shading artefacts even for mosaic images with small overlaps.

$${G}_{i}^{1} ( x , y )$$

In step S207, a first approximation of the shading function Gᵢ (x, y) can subsequently be determined by fitting of the model function Gᵢ(x, y) predefined in step S204, for example using the least squares method, to the ascertained correction factors gₖ.

Inserting the shading function

$${G}_{i}^{1} ( x , y )$$

approximately determined in S207 as Sᵢ(x, y) into the approach in step S204 then yields a first approximation of the sought object function

$${B}_{i}^{1} ( x , y ) : {B}_{i}^{1} ( x , y ) = {C}_{i} ( x , y ) / {G}_{i}^{1} ( x , y ) .$$

The iteration of the method in subsequent steps S209 to S212, the checking of the progress of the iteration by determining a distance d between

$${B}_{i}^{n} ( x , y ) and {B}_{i}^{n - 1} ( x , y )$$

in steps S213 and S214, the ending of the method with sufficient accuracy in step S215, the determination of the sample images for all tiles in step S216 and the merging of the mosaic image from the individual tile images in step S217 are then carried out analogously to the above-described steps S110 to S118 of the first exemplary embodiment of the method according to the invention.

Since the model function is generally a slowly varying function and its free parameters are calculated by way of least squares fitting, the result will not completely eliminate the luminance mismatch. However, as described, this process can be applied iteratively to the resulting sample image in order to reduce the luminance mismatch with each further iteration step. In general, the process converges after just a few iterations, for example 3 or 4 iterations.

It is also possible to iterate this method firstly for a model function for the shading function with L1 free parameters and subsequently for a more complex model function with more free parameters L2>L1.

After the calculation of the corrected mosaic images according to method variant #1 or/and according to method variant #2, mean values [symbol] Fᵢ(x, y) [symbol] , [symbol] Gᵢ(x, y) [symbol] of the ascertained approximated shading functions Gᵢ(x, y), Fᵢ(x, y) can be calculated, which can be used as reference for future recordings. This affords the advantage that this type of reference data with respect to the shading functions is calculated from typical sample capture and not from an artificial calibration sample. In particular, this allows correction even for individual images, without an image of a plurality or all of the tiles having to be recorded.

The present invention proposes a novel robust retrospective method for correcting shading artefacts for tiled images. In particular, two method variants for compensating for spatially slowly variable shading artefacts in tiled images have been described in detail. This involves the use of respective image processing methods which only use the overlapping tile regions and do not require precalibration or recording of shading reference images. The novel method does not depend on a distinction between background and foreground regions.

### LIST OF REFERENCE SIGNS

2 sample
10 radiation source, light source, e.g. laser or LED source
10 microscope stand
12 illumination radiation, illumination light, excitation light
16 emission radiation or emission light emitted by sample 2 in sample region 1
40 microscope objective
41 optical axis of the microscope objective 40
44 mechanical drive
50 detector
90 control unit
100 optical device according to the invention, microscope
(0,0) origin of the x-y-coordinate system
aᵢ parameter of the parabolic model function Fᵢ(x, y)
bᵢ parameter of the parabolic model function Fᵢ(x, y)
Bᵢ(x, y) brightness generated by the sample at the tile position (x, y) without shading effects, unshaded sample image

$${B}_{i}^{n - 1} ( x , y )$$

(n−1)-th approximation of Bᵢ(x, y)

$${B}_{i}^{n} ( x , y )$$

n-th approximation of Bᵢ(x, y)

$${B}_{i} ( {x}^{′} , {y}^{′} ) = B ( x + {a}_{i} {m}_{x} , y + {b}_{i} {m}_{y} )$$

mosaic image
B_{L} value of the sample image Bᵢ(x, y) at a left edge of the tile i
B_{R} value of the sample image Bᵢ(x, y) at a right edge of the tile i
Bᵢ(x′, y′) brightness generated by sample at the global position (x′, y′) without shading effects
Cᵢ parameter of the parabolic model function Fᵢ(x, y)
Cᵢ(x, y) brightness measured by the detector at the tile position (x, y) in the i-th tile
Cᵢ(x′, y′)=C(x+aᵢmₓ, y+bᵢm_{y}) measured brightness of the mosaic image
d distance between

$${B}_{i}^{n} ( x , y ) and {B}_{i}^{n - 1} ( x , y )$$

dᵢ parameter of the parabolic model function Fᵢ(x, y)
dₓ=w−mₓ overlap of the tiles in the x-direction
d_{y}=w−m_{y} overlap of the tiles in the y-direction
fₖ correction factors
Fᵢ(x, y) model function for shading function, parabolic function

$${F}_{i}^{n - 1} ( x , y )$$

(n−1)-th approximation of the shading function Fᵢ(x, y)

$${F}_{i}^{n} ( x , y )$$

n-th approximation of the shading function Fᵢ(x, y)
[symbol] (Fᵢ(x, y) [symbol] mean value of the approximately ascertained shading functions Fᵢ(x, y)
g horizontal direction at y=0 within a tile
gₖ correction factors
Gᵢ(x, y) model function for shading function, for example Zernike polynomial

$${G}_{i}^{n - 1} ( x , y )$$

(n−1)-th approximation of the shading function Gᵢ(x, y)

$${G}_{i}^{n} ( x , y )$$

n-th approximation of the shading function Gᵢ(x, y)
[symbol] Gᵢ(x, y) [symbol] mean value of the approximately ascertained shading functions Gᵢ(x, y)
h height of a tile image
i index of the tiles
j index of the tiles
k index of the support points
mᵢ=(αᵢmₓ, βᵢm_{y}) displacement vector for i-th tile in the mosaic image
mₓ length of grid vector in the x-direction
m_{y} length of grid vector in the y-direction
p₁ parameter of the parabolic function P(x, y)
p₂ parameter of the parabolic function P(x, y)
p₃ parameter of the parabolic function P(x, y)
p₄ parameter of the parabolic function P(x, y)
P(x, y) model function for shading function, parabolic function
S threshold for distance between

$${B}_{i}^{n - 1} ( x , y ) and {B}_{i}^{n} ( x , y )$$

Sᵢ(x, y) multiplicative shading function, multiplicative shading effect at the tile position (x, y) caused e.g. by vignetting and/or contamination on the detector, shading correction function
Tᵢ(x, y) additive shading term
v vertical direction at x=0 within a tile
w width of a tile image
x first lateral coordinate in the sample plane
x discrete integer position of a pixel within a tile image in the x-direction
x′ first global lateral coordinate
(x′, y′)=(x+aᵢmₓ, y+bᵢm_{y}) global position (x′, y′) in mosaic image
(xᵢ, yᵢ)|ₖ support points
(xⱼ, yⱼ)|ₖ support points
y second lateral coordinate in the sample plane
y discrete integer position of a pixel within a tile image in the y-direction
y′ second global lateral coordinate
αᵢ∈ [symbol] ₀
βᵢ∈ [symbol] ₀
δ distance between a specific approximately ascertained shading function βFᵢ(x, y) or Gᵢ(x, y) and a mean value of the approximately ascertained shading functions [symbol] Fᵢ(x, y) [symbol] or respectively [symbol] Gᵢ(x, y)

[symbol]

### REFERENCES

[Wu]Q. Wu, F. A. Merchant, K. R. Castleman, ‘Microscope Image Processing’, Cap. 12.5.3-12.5.6, Academic Press, Elsevier,
ISBN 978-0-12-372578-3
[Young] Young, Ian T. “Shading correction: compensation for illumination and sensor inhomogeneities.”
Current Protocols in Cytometry 14, no. 1 (2000): 2-11.
[De Silva]V. De Silva, V. Chesnokov, D. Larkin, “A Novel Adaptive Shading Correction Algorithm for Camera Systems”, 2016 Society for Imaging Science and Technology,
DOI: 10.2352/ISSN.2470-1173.2016.18.DPMI-249
[Preibisch] Preibisch, Stephan, Stephan Saalfeld, and Pavel Tomancak. “Globally optimal stitching of tiled 3D microscopic image acquisitions.” Bioinformatics 25.11 (2009): 1463-1465.
[Legesse] Legesse, Fisseha Bekele, Olga Chernavskaia, Sandro Heuke, Thomas Bocklitz, Tobias Meyer, Jurgen Popp, and Rainer Heintzmann. “Seamless stitching of tile scan microscope images.”
Journal of microscopy 258, no. 3 (2015): 223-232.
[Smith] Smith, Kevin, Yunpeng Li, Filippo Piccinini, Gabor Csucs, Csaba Balazs, Alessandro Bevilacqua, and Peter Horvath. “CIDRE: an illumination-correction method for optical microscopy.”
Nature methods 12, no. 5 (2015): 404-406.
[Peng] Peng, Tingying, Kurt Thorn, Timm Schroeder, Lichao Wang, Fabian J. Theis, Carsten Marr, and Nassir Navab. “A BaSiC tool for background and shading correction of optical microscopy images.”
Nature communications 8, no. 1 (2017): 14836.
[Loetgering] German patent application 10 2024 124 248.5

1. Method for processing tiled images in which a plurality of overlapping tile images Cᵢ(x, y) of a sample (2) are recorded (S101) by an optical device (100),
characterized in that
the following method steps are carried out for ascertaining unshaded sample images Bᵢ(x, y):
a) predefining an approach (S103)
Cᵢ(x, y)=Sᵢ(x, y)Bᵢ(x, y)+Tᵢ(x, y) for the measured tile images Cᵢ(x, y), in which
Bᵢ(x, y) is an unshaded sample image to be ascertained of a tile i,
Sᵢ(x, y) is a shading function for the tile i,
Tᵢ(x, y) is an additive shading term for the tile i
and i is a running index of the tiles;
b) predefining (S104; S204) a model function (P(x, y), Fᵢ(x, y); Gᵢ(x, y)) for the shading function Sᵢ(x, y) and a model term for the additive shading term Tᵢ(x, y),
c) determining correction factors (fₖ; gₖ; S105; S205) at a plurality of support points ((xᵢ, yᵢ)|ₖ, (xⱼ, yⱼ)|ₖ) in an overlap region of adjacent tile images (Cᵢ(x, y), Cⱼ(x, y)) using the tile images Cᵢ(x, y),
d) at least approximately determining (S108; S207) the shading function Sᵢ(x, y) and the shading term Tᵢ(x, y) by fitting the model function (P(x, y), Fᵢ(x, y); Gᵢ(x, y)) predefined in step b) to the correction factors (fₖ; gₖ), determined in step c)
e) approximately determining (S109; S208) an unshaded sample image Bᵢ(x, y) using the shading function Sᵢ(x, y) at least approximately determined in step d) and the at least approximately determined shading term Tᵢ(x, y).

2. Method according to claim 1,
characterized in that
the model function (Pᵢ(x, y), Fᵢ(x, y)) is a function which is parabolic in the x-coordinate and/or a function which is parabolic in the y-coordinate.

3. Method according to claim 1 or 2,
characterized in that
the model function (Gᵢ(x, y)) has at least one of the following polynomials or is realized by at least one of the following polynomials:
Zernike polynomial,
two-dimensional Hermite polynomial,
two-dimensional Laguerre polynomial,
Jacobi polynomial,
multivariate Bernstein polynomial.

4. Method according to any of claims 1 to 3,
characterized in that
the correction factors (fₖ; gₖ) are calculated for support points ((xᵢ, yᵢ)|ₖ, (xⱼ, yⱼ)|ₖ) which lie at edges of overlap regions of the tile images Cᵢ(x, y).

5. Method according to any of claims 1 to 4,
characterized in that
the correction factors (fₖ; gₖ) are calculated for support points ((xᵢ, yᵢ)|ₖ, (xⱼ, yⱼ)|ₖ) which lie on the coordinate axes (x, y).

6. Method according to any of claims 1 to 4,
characterized in that
the correction factors (fₖ; gₖ) are calculated for a multiplicity of support points ((xᵢ, yᵢ)|ₖ, (xⱼ, yⱼ)|ₖ) at points on the edge of a tile (i, j).

7. Method according to any of claims 1 to 6,
characterized in that
for tiles (i) at the edge of a mosaic image (Bᵢ(x′, y′)) where no overlap regions with adjacent tiles are present, correction factors (fₖ; gₖ) obtained for support points at respective opposite edges are used for the edges of the relevant tiles (i) at which no adjacent tiles are present.

8. Method according to any of claims 1 to 7,
characterized in that
for the edges of tiles (i) at the edge of a mosaic image (Bᵢ(x′, y′)) where no overlap regions with adjacent tiles are present, mean values of correction factors (fₖ; gₖ) of tiles (i) which are completely surrounded by other tiles (i) are used.

9. Method according to any of claims 1 to 8,
characterized in that
using the model function (P(x, y), Fᵢ(x, y); Gᵢ(x, y)) and assuming that the measured tile images Cᵢ(x, y) of adjacent tiles (i, j) are structurally matched to one another, values (B_{L},B_{R}) of the sample image Bᵢ(x, y) are calculated at support points on the coordinate axes and at the boundaries of the overlap regions.

10. Method according to claim 9,
characterized in that
the correction factors (fₖ) are quotients of values of the tile images Cᵢ(x, y) and the values (B_{L},B_{R}) of the sample image Bᵢ(x, y) at support points on the coordinate axes and at the boundaries of the overlap regions.

11. Method according to any of claims 1 to 10,
characterized in that
the correction factors (gₖ) are quotients of values of the tile images (Cᵢ(x, y), Cⱼ(x, y)) of adjacent tiles (i, j).

12. Method according to any of claims 1 to 11,
characterized in that
additional support points are inserted in central regions of the tile images Cᵢ(x, y), wherein the function value of the model function (P(x, y), Fᵢ(x, y); Gᵢ(x, y)) at these additional support points is set to a suitable value, for example to 1.

13. Method according to any of claims 1 to 12,
characterized in that
in step d) approximately determining the shading function Sᵢ(x, y) and in step e) approximately determining the sample images Bᵢ(x, y) are each carried out iteratively (S110-S113; S209-S212) by determining (S111; S210) updated correction factors (fₖ; gₖ) using in each case an (n−1)-th approximation of the shading function
$$( {F}_{i}^{n - 1} ( x , y ) ; {G}_{i}^{n - 1} ( x , y ) )$$
and/or an (n−1)-th approximation of the sample images
$$( {B}_{i}^{n - 1} ( x , y ) ) ,$$
determining (S112; S211) an n-th approximation of the shading function
$$( {F}_{i}^{n} ( x , y ) ; {G}_{i}^{n} ( x , y ) )$$
by fitting the correction factors (fₖ; gₖ) to the respectively predefined model function (Fᵢ(x, y); Gᵢ(x, y)) and
determining (S113; S212) an n-th approximation of the unshaded sample images
$$( {B}_{i}^{n} ( x , y ) )$$
using the n-th approximation of the shading function
$$( {F}_{i}^{n} ( x , y ) ; {G}_{i}^{n} ( x , y ) ) .$$

14. Method according to claim 13,
characterized in that
a distance (d) between
$${B}_{i}^{n} ( x , y ) and {B}_{i}^{n - 1} ( x , y )$$
is determined,
the iteration is continued if the distance (d) is greater than a threshold (S) to be defined, and
the iteration is ended if the distance (d) is less than the defined threshold (S).

15. Method according to either of claims 13 and 14,
characterized in that
the iterative method is carried out firstly for a model function for the shading function with a first number of free parameters and subsequently for a more complex model function with a second number of free parameters greater than the first number.

16. Method according to any of claims 1 to 15,
characterized in that
the resulting sample images Bᵢ(x, y) are combined to form a mosaic image (Bᵢ(x′, y′)).

17. Method according to any of claims 1 to 16,
characterized in that
the shading function Sᵢ(x, y) is calculated at least approximately individually for each tile (i).

18. Method according to any of claims 1 to 17,
characterized in that
a check is made to establish how far an individual one of the approximately ascertained shading functions (Fᵢ(x, y); Gᵢ(x, y)) deviates from a mean value ( [symbol] F(x, y) [symbol] ; [symbol] Gᵢ(x, y) [symbol] ) of the approximately ascertained shading functions, and an approximately ascertained shading function (F_{L}(x, y); G(x, y)) is replaced by the mean value ( [symbol] Fᵢ(x, y) [symbol] ; [symbol] Gᵢ(x, y) [symbol] ) if it differs from the mean value ( [symbol] Fᵢ(x, y) [symbol] ; [symbol] Gᵢ(x, y) [symbol] ) by more than a threshold (δ) to be defined.

19. Method according to any of claims 1 to 18,
characterized in that
groups of a plurality of adjacent pixels are in each case evaluated for the approximate calculation of the shading function (Fᵢ(x, y); Gᵢ(x, y)).

20. Method according to claim 19,
characterized in that
for the individual groups of a plurality of adjacent pixels, a mean value or a median of the data respectively measured by the pixels is in each case formed.

21. Method according to any of claims 1 to 20,
characterized in that
the optical device is a microscope (100).

22. Optical device
having a detector (50) for detecting emission radiation (16) emitted by a sample (2) in a sample region (1),
having a detection beam path having an imaging optical unit (40) for guiding the emission radiation (16) onto the detector (50),
having a mechanical drive (44) for setting a relative lateral position between the sample (2) and the imaging optical unit (40) with respect to an optical axis (41) of the imaging optical unit (40),
having a control unit (90) configured for controlling the mechanical drive (44) and for evaluating measurement data from the detector (50),
wherein the control unit (90) is configured to control the optical device (100) for recording (S101) a plurality of overlapping tile images Cᵢ(x, y) of the sample (2),
characterized in that
the control unit (90) is configured to carry out the following steps for ascertaining unshaded sample images Bᵢ(x, y):
a) predefining an approach (S103)
Cᵢ(x, y)=Sᵢ(x, y)Bᵢ(x, y)+Tᵢ(x, y) for the measured tile images Cᵢ(x, y), in which
Bᵢ(x, y) is an unshaded sample image to be ascertained of a tile i,
Sᵢ(x, y) is a shading function for the tile i, and
Tᵢ(x, y) is an additive shading term for the tile i
and i is a running index of the tiles;
b) predefining (S104; S204) a model function (P(x, y), Fᵢ(x, y); Gᵢ(x, y)) for the shading function Sᵢ(x, y) and a model term (0) for the additive shading term Tᵢ(x, y),
c) determining correction factors (fₖ; g; S105, S205) at a plurality of support points ((xᵢ, yᵢ)|ₖ, (xⱼ, yⱼ)|ₖ) in an overlap region of adjacent tile images (Cᵢ(x, y), Cⱼ(x, y)) using the tile images Cᵢ(x, y),
d) at least approximately determining (S108; S207) the shading function Sᵢ(x, y) and the shading term Tᵢ(x, y) by fitting the model function (P(x, y), Fᵢ(x, y); Gᵢ(x, y)) predefined in step b) to the correction factors (fₖ; gₖ), determined in step c)
e) approximately determining (S109; S208) the unshaded sample images Bᵢ(x, y) using the shading function Sᵢ(x, y) at least approximately determined in step d) and the at least approximately determined shading term Tᵢ(x, y).

23. Optical device according to claim 22,
characterized in that
the control unit (90) is configured to carry out the method according to any of claims 2 to 21.

24. Optical device according to either of claims 22 and 23,
which is embodied as an aerial image camera.

25. Optical device according to either of claims 22 and 23,
which is embodied as a microscope (100) and comprises a radiation source (10) for providing illumination radiation (12) and an illumination beam path for directing the illumination radiation (12) into the sample region (1), wherein the imaging optical unit (40) comprises a microscope optical unit.

26. Optical device according to claim 25,
characterized in that the microscope optical unit comprises at least one microscope objective (40).

27. Microscope according to either of claims 25 and 26,
which realizes at least one of the following microscopes
electron microscope,
ion microscope,
digital microscope,
fluorescence microscope,
light microscope,
transmitted light microscope,
reflected light microscope,
wide-field microscope,
scanning microscope,
confocal microscope,
light field microscope,
light sheet microscope,
TIRF microscope,
SIM microscope.
